(19) United States
(12) Patent Application Publication
(10) Pub. No.: US 2004/0170730 A1
(43) Pub. Date: Sep. 2, 2004

(54) Carbonated fruit juice beverages and process of manufacture

(76) Inventor: Mike R. Rodney, Chesterfield, VA (US)

Correspondence Address: Brian R. Reyve, Esquire, Law Offices of Brian Reyve, 161 Maple Drive, Park City, UT, 84098, US

(21) Appl. No.: 10/793,904

(22) Filed: Mar. 8, 2004

Related U.S. Application Data
(62) Division of application No. 09/957,251, filed on Sep. 21, 2001.

(51) Int. Cl. A23B 4/00

(52) U.S. Cl. 426/407

(57) ABSTRACT

A method for producing a carbonated juice beverage, and carbonated fruit beverages produced according to the method. The method includes the steps of providing a juice, typically a fruit juice, cooling and carbonating the juice to form carbonated juice, bottling the carbonated juice to form sealed bottles containing the carbonated juice, and pasteurizing the carbonated juice in the sealed bottles.

### BACKGROUND OF THE INVENTION

1. Field of Invention:

The present invention relates generally to carbonated beverages, and more particularly to carbonated juice beverages.

2. Description of Related Art

Carbonated Beverages

Carbonated beverages made primarily of carbonated water, a sugar syrup such as high fructose corn syrup, and natural or artificial flavorings are well known in the beverage industry. The carbonated beverages come pre-packaged in single serving cans and bottles, multiple serving bottles, and as separate carbonated water and syrup that are mixed while being dispensed at a soda fountain. Carbonated beverages come in a variety of natural and artificial flavors such as cola, lemon-lime, orange, root beer, and grape.

Non-Carbonated Juice Beverages

Juices are well known in the beverage industry, such as apple, grape, tomato, and mango. Juices are typically pre-packaged in single serving cans, in multiple serving cans and bottles, and as frozen concentrate for mixing with water by the consumer. The juices can be made from fresh fruit juice or from concentrated juice such as produced by the well-known evaporative concentration or freeze concentration processes.

Extending the Shelf Life of Juices

Juices are subject to spoilage and discoloration from various bacteria, fermentation by yeast, and the breakdown of cellular products and enzymes of the fruit. While preservatives are available to slow or stop such spoilage and discoloration, they can cause a detectible change in the taste of the juice. Likewise, the consumer is more aware than ever of food additives and prefers natural preservation versus chemical preservation. Various natural ways of extending the shelf life of juices without using preservatives have been tried. Pasteurization is a widely used method to extend the shelf life of beverages by killing bacteria, yeast, and other organisms in the juice that cause spoilage. See for example, U.S. Pat. No. 6,190,718 issued to Eek et al. in which is disclosed a method for making citrus juice from small blocks of frozen juice, which method includes pasteurization of the juice.

In U.S. Pat. No. 5,260,086 issued to Downton et al. is disclosed a process for making aseptic citrus sensible pulp which involves the steps of 1) extracting and finishing citrus juice containing sensible pulp to produce a pulp/juice slurry containing 30% to 50% pulp and 50% to 70% juice, 2) sterilizing the pulp/juice slurry by heating it at least to a temperature above 190° F. (88° C.) for at least 30 seconds, 3) further finishing the pulp/juice slurry in a finisher which maintains aseptic conditions to provide an aseptic pulp product containing 80% to 100% pulp and up to 20% juice, and 4) packaging the pulp product under aseptic conditions. Also disclosed are the aseptic pulp and improved citrus juice products containing the pulp.

In U.S. Pat. No. 5,468,508 issued to Wu et al. is disclosed a process for preserving the quality attributes and ascorbic acid content of fresh fruit juices and mixtures of fruit juices. The process comprises the steps of 1) sanitizing the outer surface of the fruit, 2) extracting the juice from the edible portion of the fruit, 3) gasifying the juice with an oxygen-containing, carbon dioxide-containing gas mixture, 4) filling a high gas-barrier container with the juice, 5) hermetically sealing the container, and 6) rapidly cooling the juice in the container. Alternatively, the extracted juice may be filled into the high gas barrier container and then gasified prior to hermetically sealing the container.

Carbonated Juices

Carbonation adds a pleasant tingle to beverages and can actually enhance the taste of beverages. Therefore, attempts have been made to produce a carbonated beverage that contains fresh fruit juice or fruit juice from concentrate. For example, in U.S. Pat. No. 1,336,720 issued to Baulig is disclosed a process for producing a carbonated fruit juice, comprising the steps of 1) sterilizing the fruit juice from fermentive bacilli or germs, 2) sealing the sterile juice away from the air in a glass bottle, and 3) carbonating the sterile juice while sealed away from the air in the bottle. The invention provides for carbonating the previously sterilized juice without exposing it again to air infection or contamination. The disclosure states that the carbonated juice may be kept indefinitely without chemical preservatives.

In U.S. Pat. No. 4,612,205 issued to Kupper et al. is disclosed a storage-stable carbonated beverage containing a blend of fruit, citrus, and berry juice which has the taste of cola, but which uses no kola nut extract or caramel color. One or more juices, in particular plum juice, alone or mixed with other suitable juices are used to provide the taste of a cola. The beverage comprises carbonated water, juices, acid, and natural flavors. The blend of juices includes a main juice such as plum juice, a juice that imparts tartness such as cranberry, blueberry, or raspberry, and a juice that is light in color such as apple, pear, or pineapple. Carbon dioxide is used to provide effervescence to the beverage, having a carbon dioxide level of about 0.5 to about 6.0 volume levels or volumes of carbon dioxide.

Other Carbonated Beverages

Naturally occurring liquids other than fruit juices have been carbonated. For example, in U.S. Pat. No. 5,424,089 issued to Munch et al. is disclosed a carbonated, concentrated maple sap beverage derived from maple trees. The maple sap is carbonated with carbon dioxide gas and may additionally comprise a flavoring ingredient such as a fruit flavor for complementing the taste of the maple sap. The method comprises the steps of 1) gathering sap from maple trees, 2) pasteurizing the sap without boiling for the elimination of harmful bacteria, 3) cooling the pasteurized maple sap to a temperature above its freezing point, preferably from about 35° F. to 40° F., 4) carbonating the maple sap with carbon dioxide gas, and 5) filtering the carbonated maple sap to remove impurities. The pasteurizing process is conducted by heating the maple sap with steam to a minimum temperature of 178° F. for a period of at least 3 minutes or longer to ensure the elimination and destruction of harmful bacteria. Typically, the maple sap is subjected to a temperature of approximately 200° F. for approximately 5 minutes.

Shortcomings of the Prior Art

While carbonated juices have been attempted, there are quite a few shortcomings. These include 1) difficulty in pasteurizing carbonated 100% juice beverages, 2) producing carbonated 100% juice beverages which are shelf-stable, 3) the lack of a method for carbonating 100% juices in single-serve glass bottle containers, 4) the lack of carbonated 100% juice beverages that include vitamin fortified ingredients, 5) the lack of carbonated fruit juices in single-serve packages, and 5) the lack of effective manufacturing processes that for carbonated 100% juice beverages particularly as related to the need for multiple manufacturing lines for carbonating juice beverages.

### SUMMARY OF INVENTION

1. Advantages of the Invention One of the advantages of the present invention is that it provides a method for pasteurizing carbonated 100% juice beverages.

Another advantage of the present invention is that it provides a method for producing shelf-stable carbonated 100% juice beverages.

A further advantage of the present invention that it provides a method for carbonating 100% juices in single-serve glass bottle containers.

Yet another advantage of the present invention that it provides a method that includes vitamin fortified ingredients in carbonated 100% juice beverages.

Another advantage of the present invention that it provides a manufacturing process that will allow for immediate commercial promotion of single-serve carbonated 100% juice beverages.

A further advantage of the present invention that it provides a method for carbonating single-serve 100% juice beverages on a single manufacturing line.

These and other advantages of the present invention may be realized by reference to the remaining portions of the specification, claims, and abstract.

2. Brief Description of the Invention

The present invention comprises a method for producing a carbonated juice beverage, and a carbonated juice beverage produced according to the method comprising a carbonated, pasteurized juice in a sealed container. An exemplary method of producing a carbonated juice beverage comprises the steps of 1) providing a juice, 2) cooling and carbonating the juice to form carbonated juice, 3) bottling the carbonated juice to form sealed bottles containing the carbonated juice, and 4) pasteurizing the carbonated juice in the sealed bottles. Another exemplary method of producing a carbonated juice beverage comprises the steps of 1) providing a juice, 2) pasteurizing the juice, 3) cooling and carbonating the juice to form carbonated juice, and 4) bottling the carbonated juice to form sealed bottles containing the carbonated juice.

The step of cooling and carbonating the juice preferably comprises carbonating the juice at a CO₂ carbonation rate of between about 2.4 to 3.4 volumes. The step of cooling and carbonating the juice preferably comprises cooling the juice to a temperature of between about 34° F. to 38° F. The juice may be cooled in a separate cooling tower prior to carbonization. The step of pasteurizing the carbonated juice in the sealed bottles preferably comprises the juice reaching a temperature of between about 145° F. and 185° F. using a tunnel pasteurizer.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

Preferred embodiments of the present invention are shown in the accompanying drawings wherein:

FIG. 1 is substantially a block diagram showing a single manufacturing line utilizing cold carbonating and tunnel pasteurization for practicing an exemplary method according to the present invention to produce an exemplary carbonated juice beverage also according to the present invention; and

FIG. 2 is substantially a block diagram showing a single manufacturing line utilizing cold carbonating and tank pasteurization for practicing an alternative exemplary method according to the present invention.

### DESCRIPTION OF THE PREFERRED EMBODIMENT

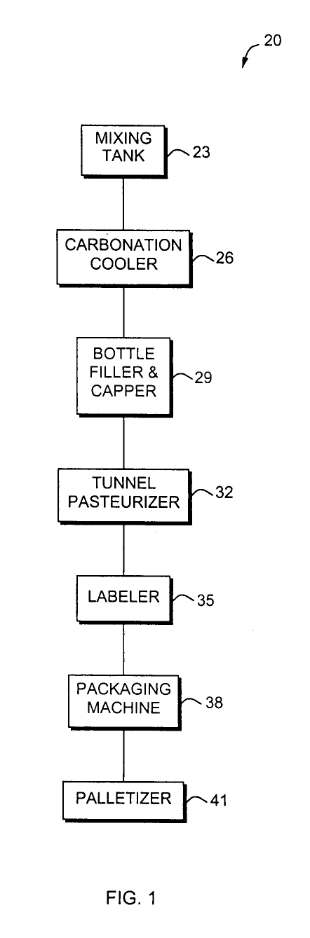

The present invention comprises carbonated juice beverages and method of producing the beverages. Referring to the block diagram of FIG. 1, a single manufacturing line, generally designated at 20, may be used to conduct an exemplary method according to the invention to produce an exemplary carbonated juice beverage according to the invention.

Manufacturing Line

The manufacturing line 20 includes standard type machinery including a mixing tank 23, a carbonation cooler 26, a filler 29, a tunnel pasteurizer 32, a labeler 35, a packaging machine 38, and a palletizer 41. The mixing tank 23 is for mixing juice concentrates, water, flavorings, colorings, and vitamin fortified ingredients emptied thereinto to produce a non-carbonated juice mixture. The carbonation cooler 26 receives the non-carbonated juice mixture from the mixing tank 23 which is subsequently cooled therein and carbonated. The carbonated juice mixture is received by the filler 29 that deposits a predetermined volume into respective single-serving beverage bottles (not shown) that are then capped. The capped bottles are sent through the tunnel pasteurizer 32 which heats the carbonated juice mixture within the bottles to a temperature sufficient to kill pathogens, preferably between about 145° F. to 185° F. Labels (not shown) are then applied to the bottles by the labeler 35 and the bottles are placed in cartons (not shown) by the packaging machine 38. The cartons of bottles are placed on pallets and wrapped with plastic sheeting by the palletizer 41 for shipment to a warehouse for subsequent shipping to customers.

Manufacturing Process

An exemplary method of producing carbonated fruit juice according to the present invention comprises the steps of:

(a) Raw ingredients including juice concentrates, water, natural flavoring, natural color, and vitamin fortified ingredients are emptied into the mixing tank 23;

(b) A juice mixture is formed by stirring the raw ingredients in the mixing tank 23;

(c) The juice mixture is transferred from the mixing tank 23 to the carbonation cooler 26;

(d) The juice mixture is carbonated at temperatures ranging from about 34° F. to 38° F. at a CO₂ (carbon dioxide) carbonation rate of about 2.4 to 3.4 volumes;

(e) The carbonated juice mixture is transferred from the carbonation cooler 26 to the filler 29;

(f) The carbonated juice mixture is bottled by filling single-serving glass bottle containers and capping;

(g) The bottled carbonated juice mixture is transferred from the filler 29 to the tunnel pasteurizer 32;

(h) The bottled carbonated juice mixture enters the tunnel pasteurizer and is heated to temperatures ranging from 145° F. to 185° F.; and

(i) The remaining manufacturing steps are completed wherein the pasteurized bottled carbonated juice mixture is labeled at the labeler 35, packaged into cartons at the packaging machine 38, and the cartons are palletized at the palletizer 41 for shipping to customers.

Note that one volume of carbon dioxide is defined as the amount of carbon dioxide absorbed by any given quantity of water at 60 degrees Fahrenheit (16° C.) temperature and atmospheric pressure. A volume of gas occupies the same space as does the water by which it is absorbed.

The carbonated beverage produced by this method has a long shelf life while not having an off flavor or bad taste due to overheating during the pasteurization step. Likewise, the carbonization level is such that the beverage has a good taste and a high enough level of CO₂ to aid in preserving the juice during storage and preventing any microbial growth.

Alternative Manufacturing Line

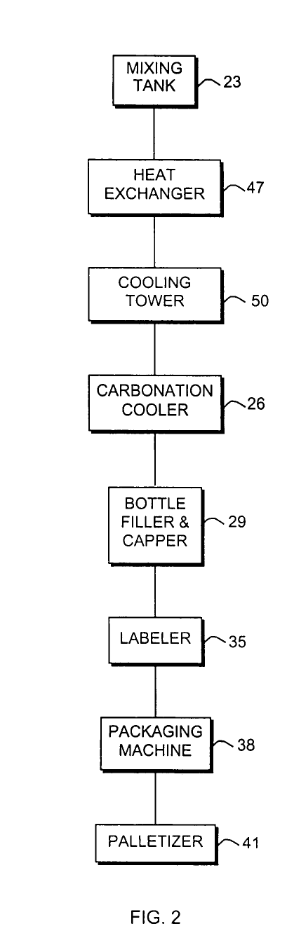

Referring to the block diagram of FIG. 2, a single manufacturing line 44 may be used to conduct an alternative exemplary method according to the invention to produce the exemplary carbonated juice beverage according to the invention.

The manufacturing line 44 includes standard type machinery as in FIG. 1, including a mixing tank 23, a carbonation cooler 26, a filler 29, a tunnel pasteurizer 32, a labeler 35, a packaging machine 38, and a palletizer 41. The manufacturing line 44 also includes a heat exchanger 47 for pasteurizing the juice mixture, and a cooling tower 50 for cooling the pasteurized juice mixture to below room temperature. The mixing tank 23 is for mixing juice concentrates, water, flavorings, colorings, and vitamin fortified ingredients emptied thereinto to produce a non-carbonated juice mixture. The heat exchanger 47 heats the non-carbonated juice mixture to a temperature sufficient to kill pathogens, preferably between about 145° F. to 185° F. The cooling tower 50 receives the hot non-carbonated juice mixture from the heat exchanger 47 and cools the juice mixture to below room temperature. The carbonation cooler 26 receives the cooled non-carbonated juice mixture from the cooling tower 50 which is subsequently further cooled therein and carbonated. The carbonated juice mixture is received by the filler 29 that deposits a predetermined volume into respective single-serving beverage bottles (not shown) that are then capped. Labels (not shown) are then applied to the bottles by the labeler 35 and the bottles are placed in cartons (not shown) by the packaging machine 38. The cartons of bottles are placed on pallets and wrapped with plastic sheeting by the palletizer 41 for shipment to a warehouse for subsequent shipping to customers.

Manufacturing Process

An exemplary method of producing carbonated fruit juice according to the present invention comprises the steps of:

(a) Raw ingredients including juice concentrates, water, natural flavoring, natural color, and vitamin fortified ingredients are emptied into the mixing tank 23;

(b) A juice mixture is formed by stirring the raw ingredients in the mixing tank 23;

(c) The juice mixture is transferred from the mixing tank 23 to the heat exchanger 47;

(d) The juice mixture is heated to temperatures ranging from 145° F. to 185° F.;

(e) The hot juice mixture is transferred from the heat exchanger 47 to the cooling tower 50;

(f) The hot juice mixture is cooled to below room temperature in the cooling tower 50;

(g) The cooled juice mixture is transferred from the cooling tower 50 to the carbonation cooler 26;

(h) The juice mixture is carbonated at temperatures ranging from about 34° F. to 38° F. at a CO₂ (carbon dioxide) carbonation rate of about 2.4 to 3.4 volumes;

(i) The carbonated juice mixture is transferred from the carbonation cooler 26 to the filler 29;

(j) The carbonated juice mixture is bottled by filling single-serving glass bottle containers and capping; and

(k) The remaining manufacturing steps are completed wherein the pasteurized bottled carbonated juice mixture is labeled at the labeler 35, packaged into cartons at the packaging machine 38, and the cartons are palletized at the palletizer 41 for shipping to customers.

### Conclusion

It can now be seen that the present invention solves many of the problems associated with the prior art. The present invention provides a method for pasteurizing carbonated 100% juice beverages. The present invention further provides a method for producing shelf-stable carbonated 100% juice beverages. The present invention still further provides a method for carbonating 100% juices in single-serve glass bottle containers. The present invention still further provides a method that includes vitamin fortified ingredients in carbonated 100% juice beverages. The present invention still further provides a manufacturing process that will allow for immediate commercial promotion of single-serve carbonated 100% juice beverages. The present invention still further provides a method for carbonating single-serve 100% juice beverages on a single manufacturing line. These and other advantages of the present invention may be realized by reference to the remaining portions of the specification, claims, and abstract.

Although the description above contains many specifications, these should not be construed as limiting the scope of the invention but as merely providing illustrations of some of presently preferred embodiments of this invention. The specification, for instance, makes reference to specific juices. However, the present invention is not intended to be limited to these specific juices. Rather it is intended that the present invention can be used with any type of juice, and even other organic liquids such as derived from plants. Thus, the scope of the invention should be determined by the appended claims and their legal equivalents rather than by the examples given.

What is claimed is:

1. A method of producing a carbonated juice beverage, comprising the steps of:
providing a juice;
pasteurizing the juice;
cooling and carbonating the juice to form carbonated juice; and
bottling the carbonated juice to form sealed bottles containing the carbonated juice.

2. The method of claim 1, wherein the step of cooling and carbonating the juice comprises carbonating the juice at a CO₂ carbonation rate of between about 2.4 to 3.4 volumes.

3. The method of claim 2, wherein the step of cooling and carbonating the juice comprises cooling the juice to a temperature of between about 34° F. to 38° F.

4. The method of claim 2, wherein the step of pasteurizing the carbonated juice in the sealed bottles comprises the juice reaching a temperature of between about 145° F. and 185° F.

5. The method of claim 4, wherein the step of cooling and carbonating the juice comprises cooling the juice to a temperature of between about 34° F. to 38° F.

6. The method of claim 1, wherein the step of providing a juice comprises providing a juice which is a mixture of a juice concentrate and water which are mixed together prior to the step of cooling and carbonating the juice to form carbonated juice.

7. The method of claim 1, wherein the step of cooling and carbonating the juice comprises cooling the juice in a cooling tower to below room temperature prior to carbonating.

8. The method of claim 7, wherein the step of cooling and carbonating the juice comprises carbonating the juice at a CO₂ carbonation rate of between about 2.4 to 3.4 volumes.

9. The method of claim 8, wherein the step of cooling and carbonating the juice comprises cooling the juice to a temperature of between about 34° F. to 38° F.

10. The method of claim 8, wherein the step of pasteurizing the carbonated juice in the sealed bottles comprises the juice reaching a temperature of between about 145° F. and 185° F.

11. The method of claim 10, wherein the step of cooling and carbonating the juice comprises cooling the juice to a temperature of between about 34° F. to 38° F.

12. The method of claim 7, wherein the step of bottling the carbonated juice comprises forming sealed single-serve bottles containing the carbonated juice.
